(19) United States
(12) Patent Application Publication
(10) Pub. No.: US 2012/0283001 A1
(43) Pub. Date: Nov. 8, 2012

(54) System and Method for Providing Configurable Player Stake-Related Insurance for Predetermined Range of Payout Positions in Competitive Wagering Games, having Automated Policy Acquisition and Claim Resolution Functions

(75) Inventor: Eugene Castro, Henderson, NV (US)

(73) Assignee: BBL ENTERPRISES, LLC, Las Vegas, NV (US)

(21) Appl. No.: 13/463,773

(22) Filed: May 3, 2012

Related U.S. Application Data
(60) Provisional application No. 61/482,183, filed on May 3, 2011.

(51) Int. Cl. G06F 17/00

(52) U.S. Cl. 463/25

(57) ABSTRACT

The present invention provides a scalable and modular system and method for dynamically providing, to participants in competitive wagering (or other prize-bearing) ranked outcome game events, easy to acquire pre-configurable insurance policies, that upon acquisition thereof for a particular game event, reduce the policyholder's risk of losing at least a portion of their stake paid into that game event, by automatically providing at least partial reimbursement of the stake, when a predefined coverage condition is met. In various embodiments thereof, the inventive system and method comprise one or more of: (1) automated selective policy acquisition infrastructure; and (2) an automated claim resolution infrastructure module. Advantageously, various embodiments of the present invention may be utilized as stand-alone platforms usable with events offered by any online competitive wagering game provider, or they may be used in as modular solutions that can be integrated into particular competitive game event provider offerings.

### CROSS REFERENCE TO RELATED APPLICATIONS

The present patent application claims priority from, the commonly assigned co-pending U.S. Provisional Patent Application Ser. No. 61/482,183, entitled “System and Method for Providing Configurable Player Stake-Related Insurance for Predetermined Range of Payout Positions in Competitive Wagering Games, having Automated Policy Acquisition and Claim Resolution Functions”, filed May 3, 2011.

### FIELD OF THE INVENTION

The present invention relates generally to competitive wagering game events that require at least one stake or fee as a prerequisite for player entry therein, and that conclude with a game event outcome record, at least in part comprising a ranked list of game participants (e.g., players) representative of the players' performance relative to one another, in which a predefined number of highest ranked players are eligible to receive corresponding prizes, and more particularly relates to a system and method for dynamically providing a pre-configurable and easy to acquire insurance policy to game participants, that upon acquisition thereof for a particular game event, reduces the policy holder's risk of losing at least a portion of their stake in that game event, by automatically providing at least partial reimbursement of the stake when a predefined coverage condition is met.

### BACKGROUND OF THE INVENTION

Virtually all competitive prize-bearing ranked outcome game events (such as poker and other wagering game tournaments, as well as in most online tournament-based Internet based competitive games), have the following key characteristics:
(1) they require game participants to take game entry-related risk (for example by payment of an event entry fee, such as a “buy-in” in poker tournaments); and
(2) at the conclusion of the game event, the performance of all game participants is ranked relative to one another, and corresponding event prizes are provided only to participants in a predetermined number of highest ranked positions (“winning positions”), with game participants in the remaining lower ranked positions (“losing positions”) suffering losses of at least their game event entry fees, which in many cases can be quite substantial.

Not surprisingly, game participants in losing positions that are ranked closest to the lowest ranked winning position, often experience a great deal of frustration in coming relatively close to some victory, but nonetheless having to walk away from a game event with empty hands. Furthermore, in larger events, players in such “almost good enough to win” event outcome positions may have performed relatively well in the event, which further adds to their frustration at a “close loss”. For many players, repeated placements over time in such “close loss” losing positions, lead to disenchantment and loss of interest in competitive stake-based game events, resulting in decreased game event participation.

As a result, attempts have been made to provide solutions to enable game participants, in losing positions that are proximal to the lowest ranked winning position, to recover at least a portion of their stake in the game event (such as their entry fee or buy-in). One set of approaches, that achieved at least some success in the field of poker tournaments (and especially online tournaments), involves the offering of special stake-related insurance policies to tournament participants that pay out only when a policy holder finishes the tournament within a certain amount of rank positions below the lowest ranked “winning” or pay-out position (also referred to as finishing “on the bubble”).

Such solutions, often referred to as “Bubble Insurance”, are offered in different variations both by game event operations, as well as by separate companies working therewith, and typically comprise many variations in their parameters and terms and conditions. For example, one previously known bubble insurance provider offers bubble policies for an insurance fee that is determined as a percentage of the buy-in/rake fee, where the number of the event outcome positions within the “bubble” that are covered by the policy are determined on a sliding scale as a portion of the total number of tournament participants (“field size”), and where the bubble policies pay out 150% of the policyholder's non-rake portion of the buy-in fee only if a policyholder finishes the game event in one of the predefined bubble positions.

Other proposed solutions, such as disclosed in the U.S. patent application Ser. No. 12/410,690 to Nardizzi et al., offer variations on the above, such as integrating the bubble insurance policy acquisition process into the flow of a poker tournament and providing a two-tier bubble policy where the players have the option of paying an additional policy fee to be eligible to get a policy payout if they finish at a rank that is outside, but close to, the conventional range of bubble position ranks—a form of a secondary bubble.

However, all previously known bubble insurance solutions suffer from a number of significant disadvantages and drawbacks that have prevented them from gaining more than a marginal level of acceptance/popularity:
(a) there is no standardization of any kind between various bubble insurance offerings, and with each provider having a myriad set of rules, policy parameters, as well as restrictions that limit their use to only certain specific types of tournament game events (or to events from predefined event operators only), players wishing to purchase bubble insurance in connection with different game events need to subject themselves to multiple different time consuming policy acquisition processes, familiarize themselves with, and track different sets of policy rules, terms and conditions for policies purchased for each corresponding game event—a complex and time-consuming endeavor unnecessarily distracting players from gameplay;
(b) in view of (a) above, unless bubble insurance is offered and provided as an integral in-house aspect of a particular poker tournament (which carries a number of legal and other complications), many players simply don't even think about (or forget the existence of) bubble insurance offerings, essentially neglecting them;
(c) because most non-in-house bubble policies comprise strict timed claim rules, policyholders must remember to check their claim eligibility after conclusion of each event for which they hold a policy, and then to formulate and submit each claim for processing within a relatively short period of time (typically within 48 hours of an event conclusion), where if they miss this deadline or if they submit their claim with any errors, the policy claim will be denied. Clearly, this arrangement places additional burdens on game participants and can lead to further frustration when otherwise eligible claims are unpaid due to a missed claim deadline or an error in a submitted claim settlement request; and
(d) the tight-knit integration of the current bubble insurance offerings with various poker tournaments, limits their utilization only in connection therewith, precluding their utilization with non-poker competitive stake-based prize-bearing game events, such as online video game tournaments, sports tournaments, “casual games” competitive events for online games utilizing virtual currencies, etc.

It would thus be desirable to provide a novel and versatile system and method for automatically offering, and dynamically providing, to participants in any competitive wagering (or other prize-bearing) ranked outcome game events, easy to acquire pre-configurable insurance policies, that upon acquisition thereof for a particular game event, reduce the policy holder's risk of losing at least a portion of their stake paid into that game event, and that automatically provide at least partial reimbursement of the stake when a predefined coverage condition is met (such as finishing the game event within a predetermined number of ranks from the lowest ranked prize-bearing position). It would further be desirable to provide a novel and versatile system and method for offering a subscription-type flexible stake-based competitive game-related insurance service in which subscribers would be able to generate pre-configured desired policy templates for one or more eligible game event types so that a corresponding pre-configured policy may be offered to them in connection with their entry into an eligible game event, requiring little more effort for acquisition than their decision to either purchase or decline the policy for that event. It would additionally be desirable to provide a novel system and method for dynamically providing competitive game stake-related insurance policies, that comprise an automated claim resolution infrastructure operable to: (a) automatically retrieve results for game events in which a policyholder recently participated and for which policy(ies) may have been purchased, (b) intelligently determine valid eligible claims for purchased policy(ies), and then (c) automatically settle the claim(s) in a manner transparent to the policyholder.

### BRIEF DESCRIPTION OF THE DRAWINGS

In the drawings, wherein like reference characters denote corresponding or similar elements throughout the various figures:

FIG. 1 is an exemplary schematic block diagram illustrating an exemplary embodiment of the inventive system for providing, to participants in competitive prize-bearing ranked outcome game events, easy to acquire pre-configurable insurance policies, that upon acquisition thereof for a particular game event, reduce the policy holder's risk of losing at least a portion of their stake paid into that game event;

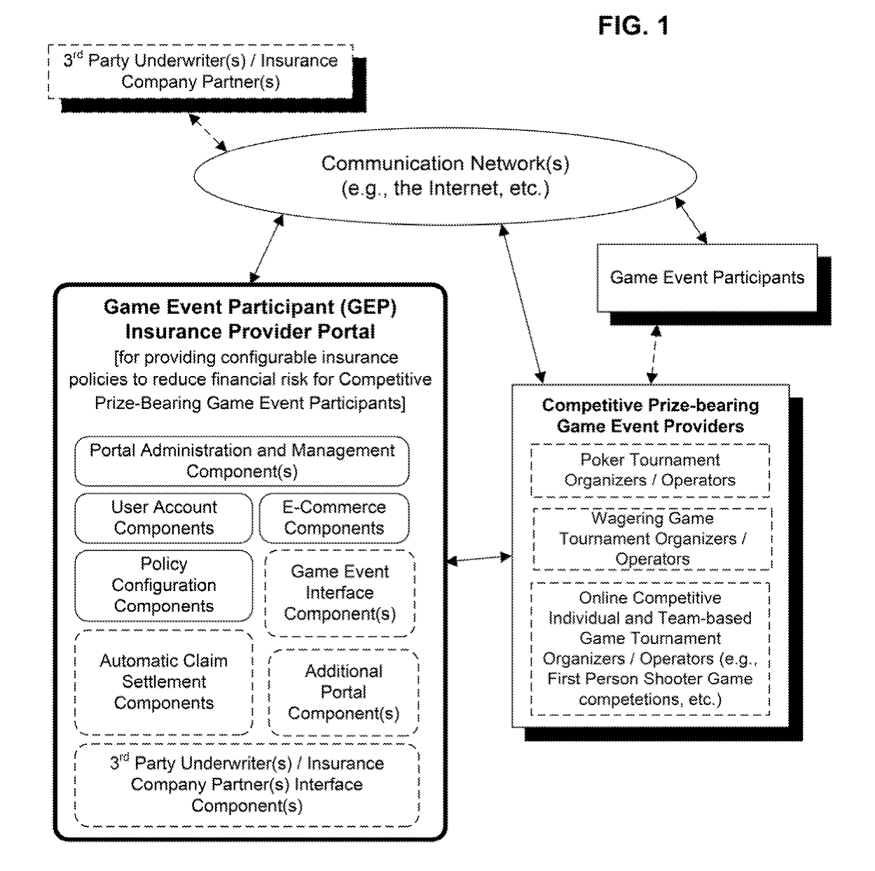

FIG. 2 is an exemplary schematic diagram illustrating an exemplary embodiment of a process flow representative of the basic operation of the inventive system of FIG. 1; and

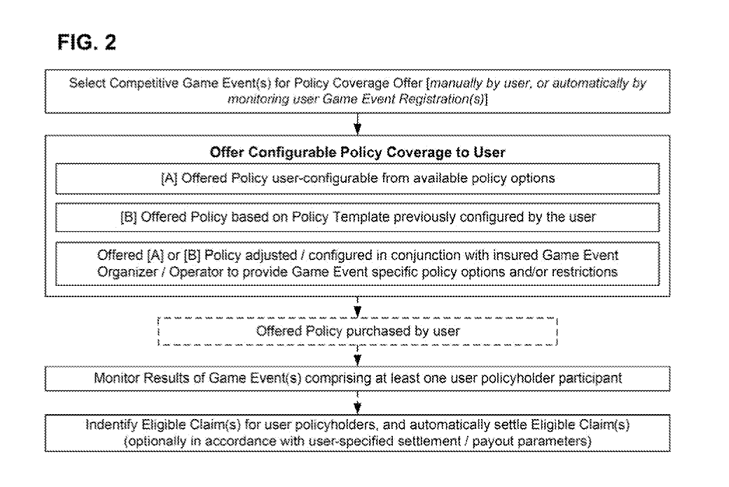

FIG. 3 is an exemplary schematic block diagram illustrating various advantageous system modules that may be readily implemented in conjunction with the inventive system of FIG. 1.

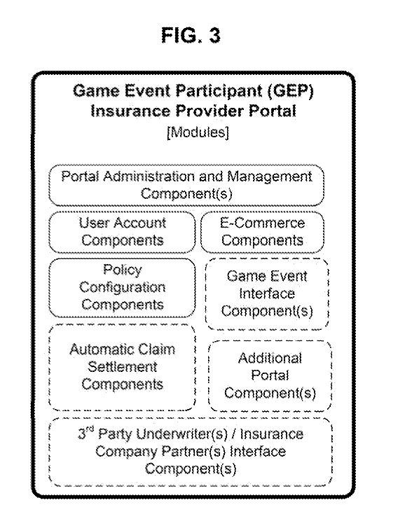

### SUMMARY OF THE INVENTION

The present invention provides a scalable and modular system and method for dynamically providing, to participants in competitive wagering (or other prize-bearing) ranked outcome game events, easy to acquire pre-configurable insurance policies, that upon acquisition thereof for a particular game event, reduce the policyholder's risk of losing at least a portion of their stake paid into that game event, by automatically providing at least partial reimbursement of the stake, when a predefined coverage condition is met. In various embodiments thereof, the inventive system and method comprise at least one of the following advantageous features:
(1) automated selective policy acquisition infrastructure (e.g. a subscription-based model, that is operable to track subscribers' entry into eligible game events, and automatically offer corresponding stake-related policies therefore based on pre-selected terms, such that subscribers need not go through a lengthy policy acquisition process for each desired game event); and
(2) an automated claim resolution infrastructure module that is operable to: (a) automatically retrieve results for game events in which a user recently participated, and for which policy(ies) may have been purchased, (b) intelligently determine valid eligible claims for purchased policy(ies), and then (c) automatically settle the claim(s) in a manner transparent to the user. Advantageously, various embodiments of the present invention may be utilized as stand-alone platforms usable with events offered by any online competitive wagering game provider, or they may be used in whole or in part as modular solutions that can be integrated into particular competitive game event provider offerings. Finally, the inventive system and method may be utilized to provide the above-noted insurance solutions in connection with any competitive game event involving entry fees (or equivalent), where only a predefined number of ranked outcomes are prize-bearing.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The system and method of the present invention addresses the flaws and disadvantages of previously known “bubble insurance”-related solutions, by providing various advantageous embodiments of a scalable and modular system and method for dynamically offering, to participants in competitive wagering (or other prize-bearing) ranked outcome game events, easy to acquire pre-configurable insurance policies, that upon acquisition thereof for a particular game event, reduces the policy holder's risk of losing at least a portion of their stake paid into that game event, by automatically providing at least partial reimbursement of the stake when a predefined coverage condition is met.

In various embodiments thereof, the inventive system and method comprise at least one of the following advantageous features:
(1) an automated selective policy acquisition infrastructure that is operable to track subscribers' entry into eligible game events, and automatically offer corresponding stake-related policies therefor (optionally based on standardized and/or pre-selected terms, such that subscribers need not go through a lengthy policy acquisition process for each desired game event), that may be implemented as an online “pop-up” (or equivalent) software module, optionally with one or more additional useful feature, such as a calculator, that also serves as reminder of policy availability to a game participant as they enter a game event;
(2) a subscription-type flexible stake-based competitive game-related insurance service infrastructure in which subscribers would be able to generate pre-configured desired policy templates for one or more eligible game event types so that a corresponding pre-configured policy may be offered to them in connection with their entry into an eligible game event, requiring little more effort for acquisition than their decision to either purchase or decline the policy for that event (optionally, various degrees of user-determined policy offering automation and/or pre-configuration can readily be provided with user-driven decision-making relating to pre-configure policy offers—from “single-click” policy purchases, to options to enable a use to re-configure all or part of their default policy template prior to purchase);
(3) automated policyholder-driven claim payout allocation, such that payouts on any settled claims may be automatically delivered/routed to a payment destination of policyholder's choice (bank account, PayPal account, etc.), or returned to the subscriber's insurance policy account for use in purchasing future policies; and
(4) automated claim resolution infrastructure that is operable to:
   (a) automatically retrieve results for game events in which a policyholder recently participated and for which policy(ies) may have been purchased,
   (b) intelligently determine valid eligible claims for purchased policy(ies), and then:
   (c) automatically settle the claim(s) in a manner transparent to the policyholder (e.g., the policyholder will not need to manually determine claim eligibility, nor will policyholders need to submits claims for settlement).

Advantageously, various embodiments of the present invention may be utilized as stand-alone platforms usable with events offered by any online competitive wagering game provider, or they may be used in whole or in part as modular solutions that can be used by particular competitive game event providers as part of their offerings. Moreover, by way of example, because any specific desired insurance policy and settlement terms and conditions can be parameterized as a matter of design choice, the inventive system and method can also readily be used to improve and enhance virtually any currently available bubble insurance service offering, such as described above, to thereby at least partially address their various flaws and disadvantages.

Finally, the inventive system and method may be utilized to provide the above-noted insurance solutions in connection with any competitive game event having at least entry fees (or equivalent), where only a predefined number of ranked outcomes are prize-bearing.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the present invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

I claim:

1. A data processing system for dynamically providing, to at least one participant in a competitive prize-bearing ranked outcome game event, a pre-configurable insurance policy comprising at least one predefined coverage condition, that upon acquisition thereof for a particular game event, reduces the policy holder's risk of losing at least a portion of their stake paid into the game event, comprising:
monitoring means for automatically determining when a game participant initiates entry into an eligible competitive game event that involves payment of an event entry-related fee; and
means for automatically offering, to said game participant, in connection with entry thereof into said eligible competitive game event, a corresponding configurable policy based on a predefined policy template compatible with said eligible competitive game event, wherein said configurable policy comprises at least one predefined coverage condition.

2. The data processing system of claim 1, further comprising:
settlement means for automatically settling a policy claim for each game participant policy holder, following the conclusion of said eligible competitive game event, holding a policy for which said at least one predefined coverage condition is met.
